(19) United States
(12) Patent Application Publication
(10) Pub. No.: US 2007/0264116 A1
(43) Pub. Date: Nov. 15, 2007

(54) Barrier-Mounted Wind-Power Generation System

(76) Inventor: Harry Edward Dempster, Newbury Park, CA (US)

Correspondence Address: JOSEPH G. SWAN;A PROFESSIONAL CORPORATION, Suite 100, 1334 Parkview Avenue, Manhattan Beach, CA, 90266, US

(21) Appl. No.: 11/746,625

(22) Filed: May 9, 2007

Related U.S. Application Data
(60) Provisional application No. 60/799,631, filed on May 12, 2006.

(51) Int. Cl. F03D 7/06

(52) U.S. Cl. 415/4.2

(57) ABSTRACT

Provided are, among other things, a system for generating energy, in which a row of wind turbines is disposed on the top side of an elongated horizontally oriented barrier, with electrical generators coupled to and driven by the turbines.

This application claims the benefit of U.S. Provisional Patent Application Ser. No. 60/799,631, filed on May 12, 2006, and titled “Roadway Divider Wind Turbine Electrical Generatoring System”, which application is incorporated by reference herein as though set forth herein in full.

### FIELD OF THE INVENTION

The present invention pertains to systems for generating electrical power from wind.

### BACKGROUND

The United States and almost all other countries are very interested in clean, renewable energy sources. Although some progress has been made, e.g., with respect to wind, ocean current and solar power, new innovations and improvements are always needed.

### SUMMARY OF THE INVENTION

The present invention addresses this need by providing wind-power electrical generation systems that are attached to the top of a barrier, such as a highway divider.

Thus, in one aspect the invention is directed to a system for generating energy, in which a row of wind turbines is disposed on the top side of an elongated horizontally oriented barrier, with electrical generators coupled to and driven by the turbines.

By virtue of the foregoing arrangement, it often is possible to easily construct an elevated array of wind turbines having a strong foundational support. In many cases, such as where the wind turbines are installed on a center dividing barrier for a highway or other road, that foundational support is already existing and, therefore, does not require any additional cost or effort to install. Also, by using the center dividing barrier for a roadway, the system often is able to capture and utilized the wind created by traffic on the roadway (as well as ambient wind and wind from other sources). Still further, the use of a row of wind turbines on the center dividing barrier of a roadway can have synergistic benefits, such as limiting visibility of oncoming traffic, including traffic accidents on the opposite side of the roadway and headlights from oncoming traffic, and providing a more elevated structure that can be used as a reflector to more noticeably indicate the existence of the barrier.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

FIG. 1 illustrates a top plan view of a road divided by a barrier, with cars on each side of the barrier traveling in the opposite direction of cars on the other side of the barrier, and with a row of wind turbines disposed on the barrier, according to a representative embodiment of the present invention.

FIG. 2 is a perspective view showing a plurality of wind turbine assemblies installed on the top side of a barrier according to a representative embodiment of the present invention.

FIG. 3 is a front centerline sectional view of a portion of a wind turbine assembly according to a representative embodiment of the present invention.

FIG. 4 is a side centerline sectional view of a portion of a wind turbine assembly according to a representative embodiment of the present invention.

### DESCRIPTION OF THE PREFERRED EMBODIMENT(S)

Millions of vehicles travel at high speeds on our highways every day and night. As they move along, they create an enormous flow of wind energy. The systems of the present invention, in addition to other benefits, often are able to collect this wasted wind energy and convert it into a clean usable electrical power resource.

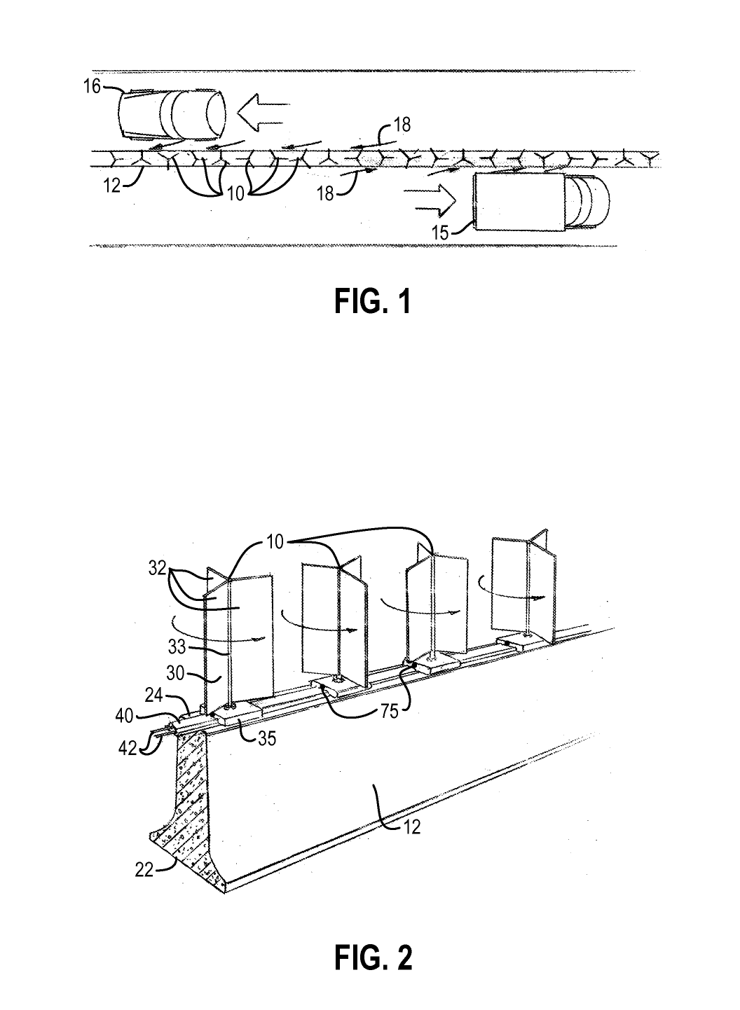

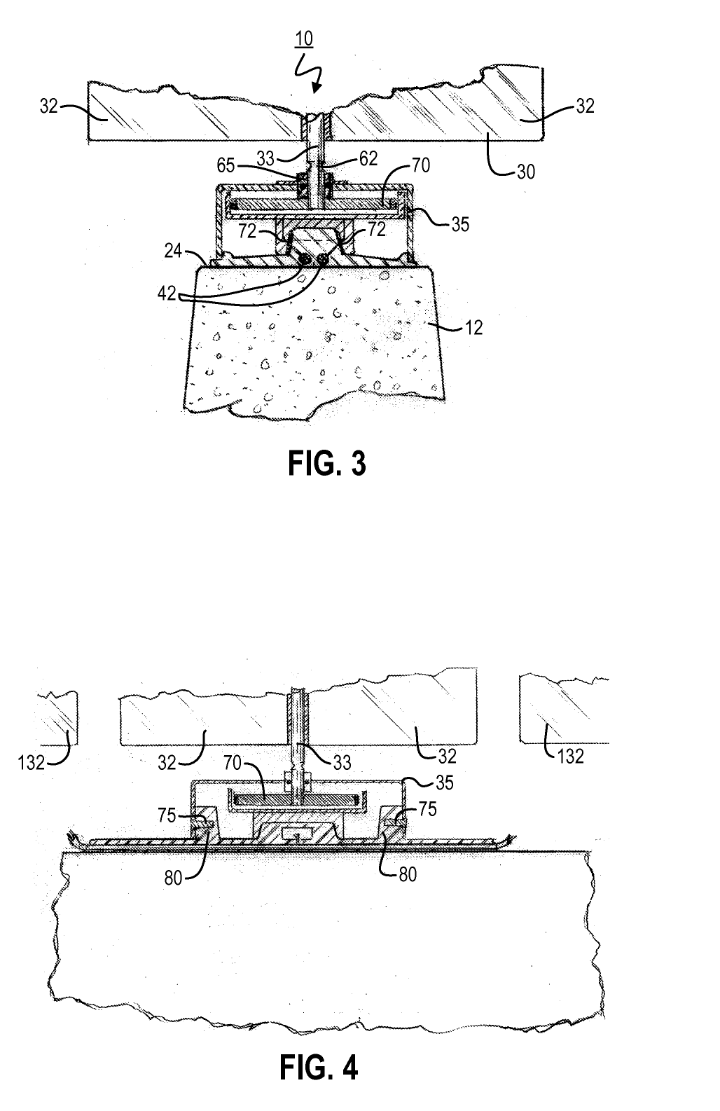

As shown in FIGS. 1-2, in a representative embodiment of the present invention, a row of vertical-axis wind turbine assemblies 10 is mounted atop a road/highway center divider/barrier 12. As cars 15-16 pass going in opposite directions, the wind 18 generated by the vehicles 15-16 turns the turbine paddles 32 to drive a number of small electrical generators (an example being shown in FIGS. 3-4). The electrical power generated by the turbine assemblies 10 is then carried by a pair of cables 42 to an electrical grid, to a storage device (e.g., a battery for storing electrical energy directly or any device for storing kinetic or chemical energy) and/or to an electrical device that will use the generated power in real-time.

The amount of electrical energy produced by a single turbine assembly 10 might be relatively small, but by placing the wind turbine assemblies 10 at closely spaced intervals (e.g., 2 feet apart) over a long distance (e.g., hundreds of yards or even miles), the total amount of energy that can be generated is substantial. Depending upon efficiency and other considerations, in certain embodiments it might be desirable to space the wind turbine assemblies 10 further apart (e.g., and a 6-12 feet apart), because placing them to closely together sometimes will reduce the efficiency of each individual unit. Nevertheless, a system according to the present invention can easily include a row having over 100, 500 or even 1,000 wind turbine assemblies.

Preferably, the wind turbine assemblies 10 are mass produced, resulting in a low per-unit cost, and are configured for low-cost maintenance and ease of replacement. In addition, the wind turbine assemblies 10 preferably are constructed from materials that do not cause any significant additional damage to a vehicle that collides with the center divider 12, or to the vehicle's passengers.

In the present embodiment, each wind turbine assembly 10 includes a paddle assembly 30, which includes a plurality of paddles 32 (preferably, three or more paddles) radially attached to a central vertically oriented power shaft 33, as well as a base portion 35 that attaches to an elongated cable casing and mounting support structure 40. The entire wind turbine assembly 10 preferably is 1½-3 feet high, more preferably approximately 2 feet high, and the surface area of each paddle 32 preferably is as large as possible, subject to or other considerations, such as not exceeding the width of the barrier 12.

It is noted that barrier 12 may be a conventional highway (or other road) dividing barrier, made of concrete and having a wider bottom side 22 than its top side 24, typically made of a large number of individual segments (e.g., each several feet long) that have been joined together. In this event, the top side 24 of barrier 12 is relatively flat and the row of wind turbines 10 preferably is mounted on this top surface, using grid cable casing and mounting support structure 40, which preferably is directly attached to the top surface of barrier 12, and which houses power transmission cables 42.

In an alternate embodiment, the barrier 12 is custom-fabricated to accept the row of wind turbine assemblies 10 and the cable casing and mounting support 40, e.g., by including a groove or other cavity running along its length, into which the cable casing and mounting support structure 40 and/or of the base portion 35 of each wind turbine assembly 10 may be mounted. Still further, barrier 12 may be any other kind of barrier, typically approximately 3-4 feet high. In any event, barrier 12 preferably is elongated, typically having a length of several hundred yards to several miles or even longer.

Irrespective of the type of barrier 12 used, the row of wind turbine assemblies 10 is disposed on the top side 24 of the barrier 12, so that each wind turbine assembly 10 extends vertically from such top side 24. It is noted that wind turbine assemblies 10 and/or cable casing and mounting support structure 40 may be attached to the top side 24 of barrier 12 using bolts, screws or other fastening devices, adhesives, and/or any other known attachment means. In the present embodiment, as discussed in more detail below, cable casing and mounting support structure 40 attaches to the top side 24 of barrier 12 and includes a sequence of mounting positions at which a wind turbine assembly 10 may be readily attached and then later detached, if necessary. Also, in the preferred embodiments, both the base portion 35 of the wind turbine assembly 10 and the cable casing and mounting support structure 40 are waterproof.

In the preferred embodiments, the turbine paddles 32 are opaque. As a result, the paddles 32 tend to inhibit the view of oncoming traffic, thereby reducing the slowing of traffic in one direction that often occurs when there is an accident or other occurrence on the other side of the road that causes motorists to slow down and look. In addition, at night, opaque paddles 32 block oncoming car headlights and, preferably, function as a light reflector, highlighting the center dividing barrier 12. For this latter purpose, the paddles 32 may be entirely reflective or may be coated, at least in part, with reflective tape, paint or other material.

FIG. 3 is a front centerline sectional view of a portion of a wind turbine assembly 10, according to a representative embodiment of the present invention, focusing primarily on the base portion 35 thereof. The paddle assembly 30 (which includes the paddles 32 and the central power shaft 33) preferably is fabricated as a monolithic unit from lightweight plastic. As a result, the entire paddle assembly 30 is unlikely to cause any significant damage in the event of a collision. More specifically, the paddles 32 attach to the power shaft 33, which supports and runs through the center of the paddles 32. The power shaft 33 preferably is provided with a weaker (e.g., narrower) breaking point 62 that allows the entire paddle assembly 30 to break away if struck by a heavy blow, without damaging the rest of the wind turbine assembly 10 (e.g., to the generator unit 70, discussed below).

The power shaft 33 continues through bearings 65 into base portion 35, which preferably is housed in a waterproof mounting container, to a small pancake electrical power generator 70. Electricity produced by the generator 70 (preferably, direct current electricity for safety purposes, which later is converted into alternating current) is transferred to the grid cables 42 within cable casing and mounting support structure 40 by contact points 72. As noted above, the grid cable casing and mounting support 40 preferably is firmly attached by fasteners and/or adhesive to the top side 24 of the concrete dividing barrier 12 and acts as a mounting bracket and electrical port for the wind turbine assembly 10.

In the preferred embodiments of the invention, the base portion 35 of the wind turbine assembly 10 preferably is no wider than the top side 24 of the barrier 12 (which typically is approximately 4-10 inches in width). At the same time, the width of the entire wind turbine assembly 10, including the paddles 32, is no wider than the width of the bottom side 22 of the barrier 12 (which typically is approximately 1½-3 feet wide).

FIG. 4 illustrates many of the same features shown in FIG. 3. In addition, FIG. 4 also shows more clearly how each wind turbine assembly 10 attaches to the cable casing and mounting support structure 40, using screws 75 in the present embodiment of the invention. Specifically, in the present embodiment cable casing and mounting support structure 40 includes sequence of mounting positions for accepting a wind turbine assembly 10. Each such mounting position, in turn, includes a pair of mounting strips 80 and an electrical port. Each such mounting strip 80 includes one or more threaded female sections (on its outer side) that align with corresponding hole(s) in the housing for base portion 35 of wind turbine assembly 10. Accordingly, in order to install a wind turbine assembly 10, the base portion 35 of the wind turbine assembly 10 is plugged into the electrical port for the desired mounting position on top of cable casing and mounting support structure 40. In doing so, base portion 35 covers the pair of mounting strips 80, with the holes in base portion 35 aligned with the holes in mounting strips 80. Finally, screws 75 are threaded into such holes, thereby securely joining base portion 35 to cable casing and mounting support structure 40.

By virtue of the foregoing arrangement, wind turbine assemblies 10 can be easily removed and replaced in a modular fashion. In a similar manner, the cable casing and mounting support structure 40 preferably also is comprised of interlocking and electrically engaging sections so that any portion of it become damaged, that portion can be simply removed and replaced. However, as noted above, due to the breakaway nature of the paddle assembly 30 in the present embodiment of the invention, the occurrence of damage to an entire wind turbine assembly 10 or to the cable casing and mounting support 40 should be reduced.

Although not shown in the drawings, in certain embodiment of the invention, such as where the individual wind turbine assemblies 10 attach to a power grid, a controller is provided within base portion 35. As is known in the art, such a controller ensures that the output voltage of the wind turbine assembly 10 matches the voltage of the power grid.

In the embodiments described above, a separate generator is provided for each wind turbine. Accordingly, in the embodiments where the power from the individual wind turbines is to be combined, a separate controller generally will be provided for each wind turbine as well. It in order to avoid such costs, and alternate embodiments a sequence of wind turbines is mechanically linked together, with the kinetic output driving a single generator.

In FIG. 4, paddles 132 for the two adjacent wind turbine assemblies also are shown. In the present embodiment, the wind turbine assemblies 10 are closely spaced together, with only a small gap between their respective paddles 32 and 132. However, as noted above, in alternate embodiments a larger gap is used, e.g., to increase per-unit efficiency.

### Additional Considerations.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A system for generating energy, comprising:
an elongated horizontally oriented barrier having a top side;
a row of wind turbines disposed on the top side of the barrier; and
a plurality of electrical generators coupled to and driven by the turbines.

2. A system according to claim 1, wherein the row of wind turbines comprises at least 100 wind turbines.

3. A system according to claim 1, wherein the wind turbines are vertical-axis wind turbines.

4. A system according to claim 1, wherein the wind turbines have paddles that readily break away upon impact.

5. A system according to claim 1, wherein the wind turbines extend at least 1½ feet above the top side of the barrier.

6. A system according to claim 1, wherein the wind turbines further comprise light reflectors.

7. A system according to claim 1, wherein the wind turbines are opaque.

8. A system according to claim 1, wherein the wind turbines are spaced apart by approximately 2 feet.

9. A system according to claim 1, wherein each wind turbine is coupled to its own generator.

10. A system according to claim 1, wherein the generators are electrically coupled to, and supply power to, an electrical power grid.

11. A system according to claim 10, wherein a cable connecting the generators to the electrical power grid runs along a top surface of the barrier.

12. A system according to claim 1, wherein the barrier separates traffic moving in opposite directions on a highway.

13. A system according to claim 1, further comprising an elongated mounting support, running along the top side of the barrier, to which the wind turbines attach in a modular fashion.

14. A system according to claim 13, wherein the elongated mounting support comprises a series of electrical ports for wind turbine assemblies.

15. A system according to claim 13, wherein the elongated mounting support comprises a plurality of fastener attachment modules for a corresponding plurality of wind turbine assemblies.

16. A system according to claim 13, wherein the elongated mounting support comprises a series of discrete mounting positions at which a wind turbine may be mounted.
